(19) United States
(12) Patent Application Publication
(10) Pub. No.: US 2020/0337136 A1
(43) Pub. Date: Oct. 22, 2020

(54) DEVICE FOR LIMITING CURRENT

(71) Applicant: Agrify Corporation, Atlanta, GA (US)

(72) Inventor: William B. WIKE, Cary, NC (US)

(21) Appl. No.: 16/841,177

(22) Filed: Apr. 6, 2020

Related U.S. Application Data
(60) Provisional application No. 62/830,770, filed on Apr. 8, 2019.

(51) Int. Cl. H05B 45/50; H02H 9/02; H05B 45/14

(52) U.S. Cl. CPC H05B 45/50; H05B 45/14; H02H 9/02

(57) ABSTRACT

A current limiting device coupled with a light emitting diode (LED) driver and with a plurality of LED lights, the LED driver supplying current to each of the plurality of LED lights, the current limiting device comprising current sensing circuitry configured to monitor a current value in each of the plurality of LED lights; determine that the current value in one of the plurality of LED lights exceeds a specified threshold; and, in response to the determination, cause the LED driver to reduce the current supplied to each of the plurality of LED lights.

### CROSS-REFERENCE TO RELATED APPLICATIONS

This application claims the benefit of U.S. Provisional Patent Application No. 62/830,770, filed Apr. 8, 2019, the entire disclosure of which is herein incorporated by reference.

### FIELD

The present disclosure relates, in exemplary embodiments, to lighting systems, and more particularly, to a current limiting device in a lighting system.

### BRIEF DESCRIPTION OF THE DRAWINGS

The drawings disclose exemplary embodiments in which like reference characters designate the same or similar parts throughout the figures of which:

FIG. 1 is a block diagram of a lighting system including a current limiting device according to one exemplary embodiment;

FIG. 2 is a block diagram of the current limiting device of FIG. 1 according to one exemplary embodiment;

FIG. 3 is a flow diagram of a method that may be performed by the current limiting device of FIG. 1 for managing current driven to light emitting diode (LED) light fixtures according to one exemplary embodiment; and

FIG. 4 is a schematic diagram of the current limiting device of FIG. 1.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Exemplary embodiments presented herein disclose techniques for managing current driven by a light emitting diode (LED) driver to LED luminaires (also referred to herein as “LED lights”) where the driver is of a different UL Class than the LED lights. Generally, UL refers to Underwriting Laboratories, an industry safety standards organization that designates a UL class to a lighting component based on a standard of compliance achieved by that component. For example, a LED driver having a UL Class 1 designation has a high-voltage output that lends to being able to drive current to a relatively higher number of LED lights compared to a driver having a UL Class 2 designation, which has a lower voltage output but also subject to fewer safety protections than the Class 1 LED driver. However, to drive multiple Class 2 LED lights by a Class 1 LED driver and comply with UL safety standards, the product of a peak current value and a peak voltage value should not exceed an amount specified by the standard, (e.g., 100 to 150 W). To address this, as further described herein, embodiments disclose a current limiting device to regulate current output by a LED driver, such as, but not limited to, a Class 1 LED driver that supplies current to one or more Class 2 LED lights.

Advantageously, a current limiting approach allows high efficiency Class 1 LED drivers to supply power to multiple high efficiency Class 2 LED luminaire and comply with UL safety standards. For instance, if a given LED light (or group of lights) fails, the current limiting device can cause the LED driver to reduce total current driven to the remaining LED lights such that the current remains the same thereon and within UL safety standards. Consequently, an overload to the LED lights is also avoided.

The following description illustrates a current limiting device as one exemplary approach for regulating power supplied to one or more Class 2 LED luminaires by a Class 1 LED driver. One of ordinary skill in the art will recognize that embodiments presented herein may be adapted to a variety of UL Class components in a lighting system, such as, but not limited to, a LED driver and LED luminaires of the same UL Class to maintain current within a preconfigured range.

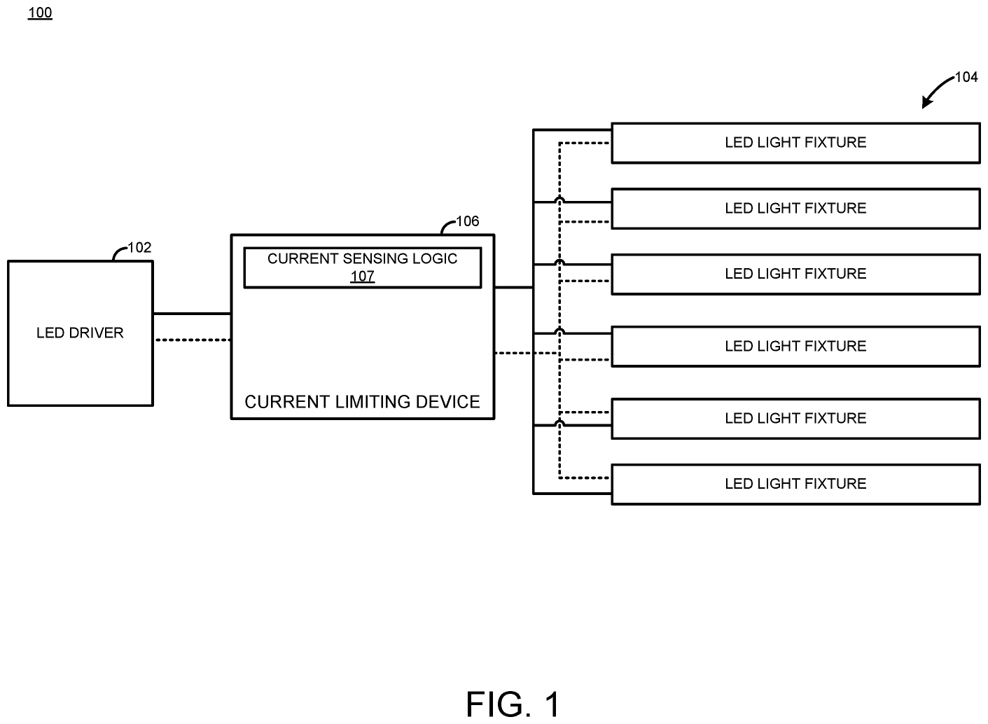

Referring now to FIG. 1, one exemplary embodiment of a lighting system 100 in which a current limiting device 106 operates is shown. The lighting system 100 includes a LED driver 102 and multiple LED light fixtures 104. The illustrative lighting system 100 may be adapted to a variety of usage applications, such as a lighting system in an indoor agriculture environment that relies on numerous LED light fixtures to promote seed-to-plant cultivation.

The LED driver 102 may be embodied as any type of hardware or circuitry to provide electricity to the one or more LED lights, such as, but not limited to, lights of the LED light fixtures 104. The LED driver 102 may control the amount of electricity driven to the LED light fixtures using pulse width modulation (PWM) techniques, e.g., to create a dimming effect on the LED light fixtures 104. In one exemplary embodiment, the LED driver 102 represents a UL Class 1-compliant LED driver that provides high-voltage output subject to safety protections specified by UL standards.

Each of the illustrative LED light fixtures 104 are representative of a chain of multiple LED lights. In an embodiment, each LED light is representative of a UL Class 2-compliant LED light that provides light at various ranges, such as, but not limited to, a range of 80 W to 96 W. In some cases, it is desirable to maintain the LED light fixtures 104 at a given range, such as, but not limited to, the aforementioned indoor agriculture environment to allow for consistent cultivation. Further, in an embodiment, each LED light in the LED light fixtures 104 may include central processing unit (CPU) components and sensor hardware (not shown) to detect a current thereon.

Illustratively, each of the LED driver 102 and the LED light fixtures 104 are interconnected with the current limiting device 106, which may be embodied as any device or circuitry to regulate a current that is output by the LED driver 102. As shown, the current limiting device 106 includes a current sensing logic 107, which is configured to monitor current driven to each of the LED lights in the LED light fixtures 104 (e.g., by obtaining current values from current sensors on the individual LED lights). Further, the current limiting device 106 may evaluate the monitored currents in each LED light against a specified threshold, which may be indicative of a measure of a current that complies with UL safety standards. If the current measured in the lights exceeds the specified threshold, the current limiting device 106 may cause the LED driver to reduce the total output to the LED light fixtures 104, thereby preventing an overload of current to the LED lights. The current limiting device 106 may be embodied as a variety of devices or circuitry, such as, but not limited to, at least one current sensing resistor, current transformer, or hall-based device.

Although the lighting system 100 depicts the LED driver 102, LED light fixtures 104, and current limiting device 106 are illustrated as separate components, one of ordinary skill in the art will recognize that the components may be combined or further separated into sub-components. For example, the current sensor logic 107 may be incorporated into the LED driver 102 or in one or more of the LED light fixtures 104.

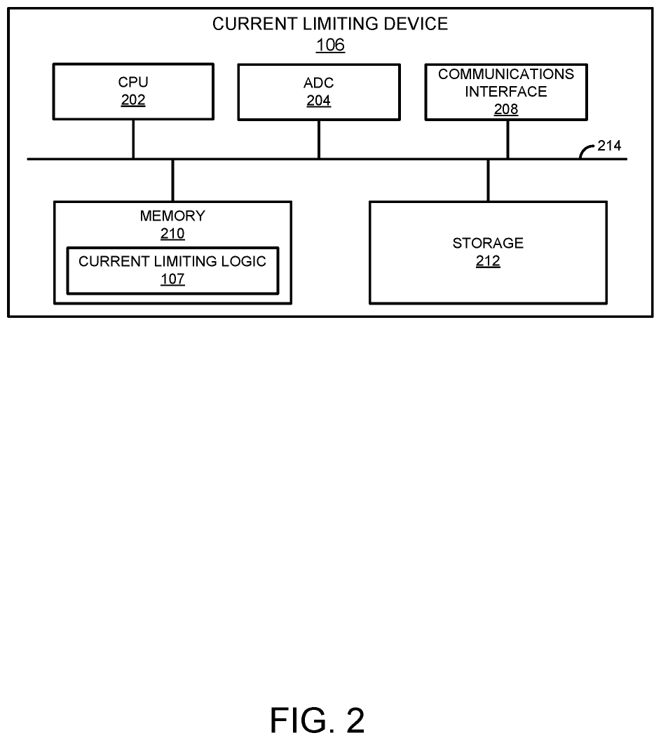

Referring now to FIG. 2, a block diagram of exemplary components of the current limiting device 106 is shown. The current limiting device 106 may include, without limitation, a central processing unit (CPU) 202, an Analog-to-Digital converter (ADC) 204, a communications interface 208, a memory 210, and a storage 212. Each component may be interconnected via an interconnect bus 214.

The CPU 202 retrieves and executes programming instructions stored in memory 210 as well as stores and retrieves data residing in the storage 212. The bus 214 is used to transmit programming instructions and data between CPU 202, communications interface 208, memory 210, and storage 212. The CPU 202 is included to be representative of a single CPU, multiple CPUs, a single CPU having multiple processing cores, and the like.

The illustrative ADC 204 may be embodied as any device or circuitry for converting analog signals obtained from sensors to digital signals. The ADC 204 may receive a voltage signal from a power supply of the LED driver 102 and convert the voltage signal to digital data used to provide the current limiting logic 107 with a digital reading of current.

The communications interface 208 may be embodied as any communication circuit, device, or collection thereof, capable of enabling communications with the LED driver 102 and communications sensors in each of the LED light fixtures 104. For example, the communications interface 208 may be embodied as any device or circuitry for enabling communications over a network, such as, but not limited to, a local area network, between the LED driver 102 and the LED light fixtures 104.

The memory 210 is generally included to be representative of a random access memory. The storage 210 may be a disk drive storage device. Although shown as a single unit, storage 212 may be a combination of fixed and/or removable storage devices, such as fixed disc drives, removable memory cards, or optical storage, network attached storage (NAS), or a storage area network (SAN). The illustrative memory 210 includes the current sensing logic 107 described relative to FIG. 1.

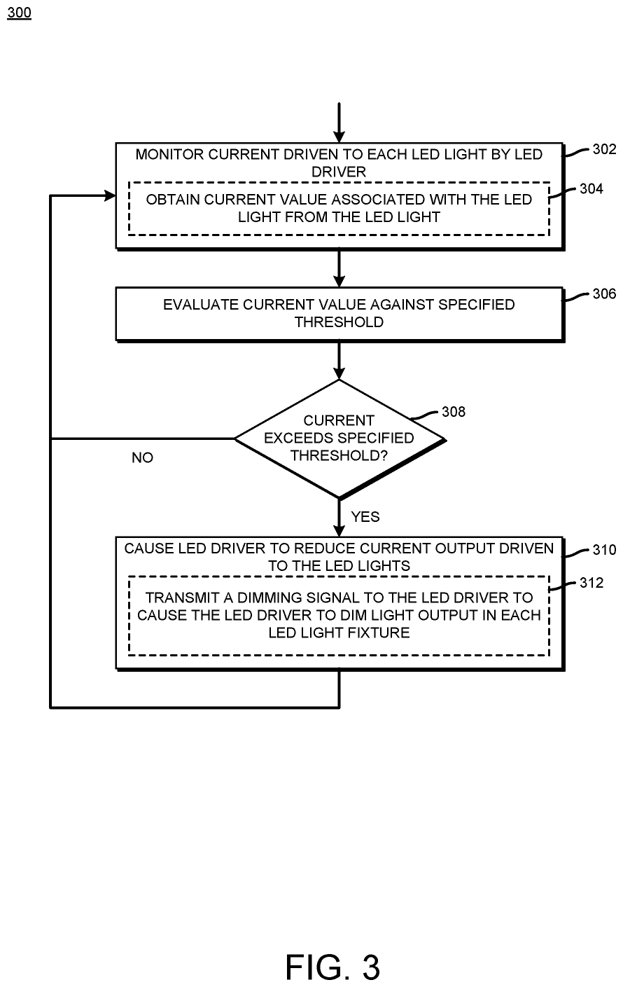

Referring now to FIG. 3, one exemplary embodiment is shown of a method using the current limiting device 106 for regulating current driven to one or more LED lights (e.g., the LED lights of the LED light fixtures 104). For instance, a method 300 may be carried out by the current sensing logic 107 of the current limiting device 106. As shown, the method 300 begins in block 302, in which the current limiting device 106 monitors current driven to each LED light of the LED light fixtures 104 by the LED driver 102. To do so, for example, in block 304, the current limiting device 106 obtains a current value from each LED light. The LED light may obtain such a value using current sensor circuitry provided thereon.

In block 306, the current limiting device 106 measures the current value of a given LED light against a specified threshold value. The threshold value may be indicative of a current that complies with a safety standard, such as, but not limited to, a UL Class 2 safety specification for the LED light. In block 308, the current limiting device 106 determines whether the current exceeds the specified threshold. The current of a given LED may exceed the specified threshold in several cases. For example, if a given LED light or group of LED lights in the light fixture fails, the current value in the remaining LED lights may increase.

If the current does not exceed the specified threshold, the method returns to block 302, in which the current limiting device 106 continues to monitor the current in each LED light. If not, then in block 310, the current limiting device 106 causes the LED driver to reduce the current output driven to the LED lights. For example, to do so, in block 312, the current limiting device 106 may transmit an analog signal or a PWM signal (or other type of signal) to the LED driver 102 indicating to the LED driver 102 to reduce current. In doing so, the LED driver 102 may dim the LED lights in the LED light fixtures 106.

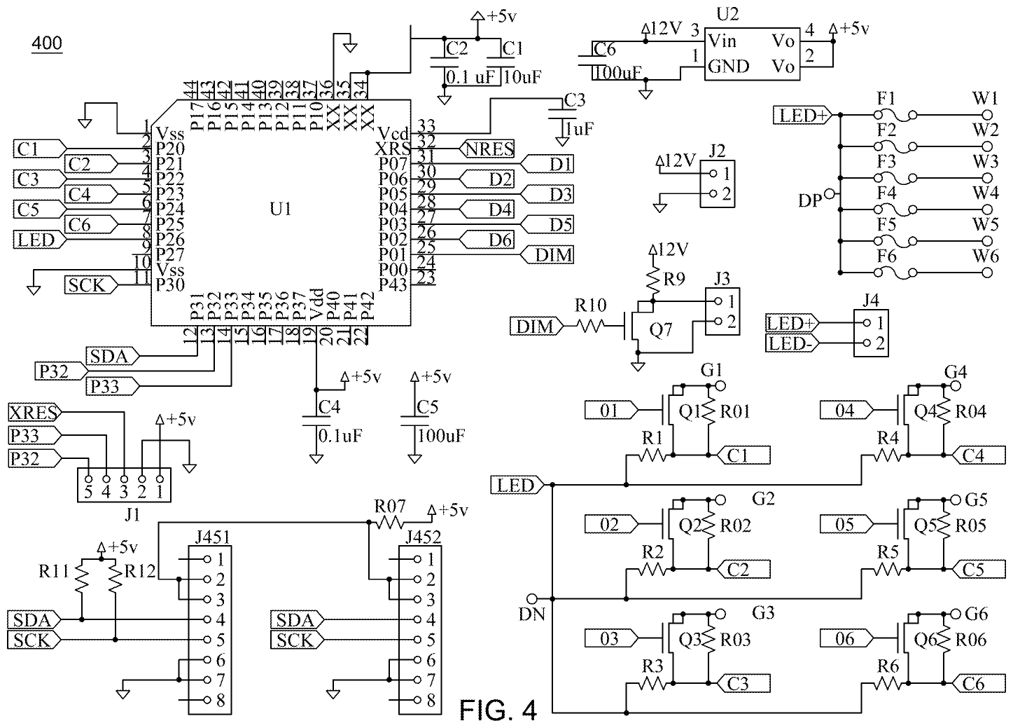

Referring now to FIG. 4, a schematic diagram 400 of one exemplary embodiment of the current limiting device 106 is shown. Particularly, the schematic diagram 400 provides various components of the current limiting device 106. The schematic diagram 400 depicts a circuitry of the current limiting device 106 that is designed to “fail open.” In particular, if a part of the circuitry fails, no current will be driven to any of the LED lights.

Further, in an embodiment, the current limiting device 106 may include additional components. For example, the current limiting device 106 may include a series fuse thereon. The series fuse allows the current limiting device 106 provides additional redundancy in the event of a failure. Further still, in an embodiment, the lighting system 100 may include a switching transistor configured in series with each light fixture 104 and coupled with the current limiting device 106. Doing so provides the current limiting device 106 with further control regarding which of the lights to activate or deactivate based on the excess of current. More particularly, the current limiting device 106, rather than deactivate every light fixture 104 in response to a current value exceeding a threshold, deactivate a subset of the light fixtures 104 such that the current is reduced to a predefined value.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

This holds for any possible non-express basis for interpretation, including: matters of logic with respect to arrangement of steps or operational flow; plain meaning derived from grammatical organization or punctuation; the number or type of embodiments described in the specification.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” or “e.g.” means “an example of” and is not intended to convey an indication of a preferred or ideal embodiment nor is it intended to limit the possible embodiments. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It should further be understood that the computer upon which the mobile software application is running may be coupled to a plurality of communication channels that allow the computer to communicate with other computing devices, e.g., servers, processors, etc. over, for example, one or more communication networks. As such, it should be understood that communication channels are examples of communications media, which typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Further, the present method and system may also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions.

It should further be noted that any patents, applications and publications referred to herein are incorporated by reference in their entirety.

What is claimed is:

1. A current limiting device coupled with a light emitting diode (LED) driver and with a plurality of LED lights, the LED driver supplying current to each of the plurality of LED lights, the current limiting device comprising:
current sensing circuitry configured to
monitor a current value in each of the plurality of LED lights;
determine that the current value in one of the plurality of LED lights exceeds a specified threshold; and
in response to the determination, cause the LED driver to reduce the current supplied to each of the plurality of LED lights.

2. The current limiting device of claim 1, wherein the LED driver is a UL Class 1 compliant driver and wherein each of the plurality of LED lights is a UL Class 2 LED light.

3. The current limiting device of claim 2, wherein the specified threshold is indicative of a current value complying with a UL Class 2 safety standard.

4. The current limiting device of claim 1, wherein to cause the LED driver to reduce the current supplied to each of the plurality of LED lights comprises to transmit a dimming signal to the LED driver, wherein the dimming signal is to cause the LED driver to dim output of light by each of the plurality of LED lights.

5. The current limiting device of claim 4, wherein the dimming signal is an analog signal.

6. The current limiting device of claim 4, wherein the dimming signal is a pulse-width-modulation signal.

7. The current limiting device of claim 1, further comprising a series fuse.
